(19) United States
(12) Patent Application Publication
(10) Pub. No.: US 2021/0209709 A1
(43) Pub. Date: Jul. 8, 2021

(54) SYSTEM AND METHOD FOR IMPLEMENTING A DIGITAL RIGHTS MANAGEMENT ADOPTION REFERENCE ARCHITECTURE

(71) Applicant: JPMorgan Chase Bank, N.A., New York, NY (US)

(72) Inventor: Ilya SLAVIN, Brooklyn, NY (US)

(21) Appl. No.: 17/142,395

(22) Filed: Jan. 6, 2021

Related U.S. Application Data
(60) Provisional application No. 62/957,440, filed on Jan. 6, 2020.

(51) Int. Cl. G06Q 50/18; G06Q 10/10; G06Q 30/00; G06Q 40/06; G06Q 20/12; G06F 21/10; G06N 20/00; G06N 5/04

(52) U.S. Cl. CPC G06Q 50/188; G06Q 10/10; G06Q 30/0185; G06Q 40/06; G06F 2221/0766; G06F 21/105; G06N 20/00; G06N 5/04; G06Q 20/1235

(57) ABSTRACT

An embodiment of the present invention is directed to a reference architecture to facilitate streamline planning and distribution of effort between internal resources, vendors and content providers, all of whom need to properly align deliverables in order to achieve maximum benefit of straight-through processing in a minimal amount of time and effort.

### CROSS REFERENCE TO RELATED APPLICATIONS

The application claims priority to U.S. Provisional Application 62/957,440 (Attorney Docket No. 72167.001811), filed Jan. 6, 2020, the contents of which are incorporated herein in their entirety.

### FIELD OF THE INVENTION

The invention relates generally to a system and method for implementing a Digital Rights Management (DRM) adoption reference architecture.

### BACKGROUND OF THE INVENTION

Digital Rights Management (DRM) is an evolution in managing the life-cycle of market data. This is a focus area for the financial industry. Currently, there is no automation in this space—agreements and compliance are managed manually. For example, large financial companies may have thousands of active agreements at any one time with hundreds of information providers, many of which are monopolies in their respective niches. Many of these agreements have poorly defined terms and oftentimes there are multiple licenses for different use cases with the same assets. This creates a massive risk of non-compliance due to obscurity of the subject matter which leads to audit exposure, hidden legal risk, opportunity loss as well as settlements in extreme circumstances.

These and other drawbacks exist.

### SUMMARY OF THE INVENTION

According to various embodiments, the invention relates to a series of business processes and automated workflows. According to an embodiment, a system implements a reference architecture for adopting digital rights management. The system comprises: an electronic input configured to receive license data from one or more sources; and a computer processor coupled to the electronic input and further programmed to perform the steps of: receiving, via the electronic input, a license agreement in rights expression language; performing, via a visualization tool, a validation of the license agreement; identifying a source of the license agreement; based on the identified source, initiating an override or a negotiation of one or more terms of the license agreement; and upon validation of the license agreement, storing, via a policy store, one or more terms of the license agreement; wherein the risk of accepting terms that are different from a negotiated paper agreement are substantially minimized.

According to another embodiment, the system comprises: a platform that manages multiple data stores comprising a policy store, identity data store and inventory store; and a computer processor coupled to the platform and further programmed to perform the steps of: accumulating a plurality of digital license agreements in rights expression language; identifying one or more entitlements associated with the license agreement in rights expression language, wherein the one or more entitlements comprise multiple parameters comprising: identity of an intended user, content associated with the license agreement and how the content is to be used; and applying, in real-time, analytics to the one or more entitlements to identify one or more of: predictions, trends, one or more errors and potential abuse of entitlement information; wherein rights enforcement is expanded to a multi-dimensional view that considers the multiple parameters to enable decision making in real-time.

According to yet another embodiment, the system comprises: an electronic input in communication with a real-time analytics and machine learning system; and a computer processor coupled to the electronic input and further programmed to perform the steps of: performing data mapping based on machine learning data from the electronic input and one or more decisions made by at least one entitlement system; applying analytics, based on the data mapping, that capture a plurality of metrics comprising: whether information was accessed, how the accessed information was used, whether the access was compliant with one or more policies; responsive to a user request, automatically generating one or more access reports comprising the plurality of metrics associated with the license agreement; and displaying, via an interactive user interface, the one or more access reports; wherein multiple data dimensions are introduced into the data mapping process and automated generation of reports.

An embodiment of the present invention may include a specially programmed computer system comprising one or more computer processors, interactive interfaces, electronic storage devices, and networks. The computer implemented system and method described herein provide unique advantages to entities, users and other participants, according to various embodiments of the invention. An embodiment of the present invention is directed to automating the value chain through license adoption, rights enforcement and reporting and analytics. A reference architecture of an embodiment of the present invention facilitates and streamlines planning and distribution of effort between internal resources, vendors and content providers to achieve a maximum benefit of straight-through processing with minimal time, effort and resources. An embodiment of the present invention may involve several related business process workflows, automation steps and technical pieces that describe how a digital contract may enter an organization, be accepted or rejected, and how it may be utilized once adopted. This may be achieved through marshalling a combination of processes.

An embodiment of the present invention is directed to License Adoption that minimizes the legal risk of effectively accepting terms that are different from a negotiated “paper” agreement (or other source), which carry the force of law. When deployed, an embodiment of the present invention may also prevent the current strategy, where data providers “sneak” terms into public agreements they post on their web sites in the hopes that such terms would not be challenged in time. This practice has generated a number of scenarios where entities are effectively obligated to enforce rules they cannot even detect. With an embodiment of the present invention, a series of decision gates may accept a new/changed agreement and further cause it to go back to the information owner for modification or other action. For example, if the ODRL was written internally or by a third party that does not own the intellectual property (e.g., an agreement is converted to ODRL), an organization may modify it or add “overrides” that clarify meaning of terms to standards. ODRL (Open Digital Rights Language) is of particular interest to the Financial Services industry due to its ability to express complex agreements. ODRL is a policy expression language that represents statements about the usage of content and services. This is particularly relevant in the Market Data domain. Market Data generally refers to price and trade-related data for a financial instrument and associated indices generated by trading venues.

Another embodiment of the present invention is directed to Rights Enforcement that may be applied once an organization accumulates a number of digital agreements. These agreements may come from originators of data, but may also be created in-house, thus effectively bypassing the License Adoption process. The Rights Enforcement process may be aimed to liberate decision making of rights enforcement over content from a narrow two-dimensional view (based entirely on identify and content being requested) to a multi-dimensional view that considers multiple parameters, including how the content is to be used and accordingly adjust decision making in real-time.

Yet another embodiment of the present invention is directed to Reporting and Analytics. An embodiment of the present invention introduces far more data dimensions into a data mapping process. For example, by taking into account nuanced decisions made by entitlements systems, reports to vendors may not only list the fact information was accessed, but how it was used, if access was compliant with embargo policies related to this service, etc. By taking into account input from real-time analytics and machine learning components, new license paradigms may be created and successfully reported on, such as micro-payments for access to information rather than a subscription model that exists today, usage cap, etc. Moreover, the innovative DRM decision support platform may drive automated generation of reports instead of custom-building each one, currently in use today.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the present invention.

FIG. 1 is an exemplary process flow, according to an embodiment of the present invention.

FIG. 2 is an exemplary system diagram, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art in light of known systems and methods, would appreciate the use of the invention for its intended purposes and benefits in any number of alternative embodiments, depending upon specific design and other needs.

As standards for rights languages that describe terms needed in this area emerge in standards bodies, like W3C's Open Digital Rights Language (ODRL), a reference architecture for how they would enter the value chain inside an organization, such as a bank or financial institution, is required to highlight components that need to be built, interfaces between steps, automation opportunities, etc. An embodiment of the present invention is directed to a reference architecture that streamlines planning and distribution of efforts between internal resources, vendors and content providers, all of which need to properly align deliverables in order to achieve maximum benefit of straight-through processing with minimal time and effort.

An embodiment of the present invention is directed to a process for adopting digital contracts into an existing or a new environment. An embodiment of the present invention is directed to achieving a maximum level of automation and compliance in this space, e.g., adoption of the licenses, enforcement of entitlements and reporting usage to intellectual property owners. The embodiments of the present invention may be extended to automate other processes to further expand this architecture to various applications, use cases, scenarios, industries, etc.

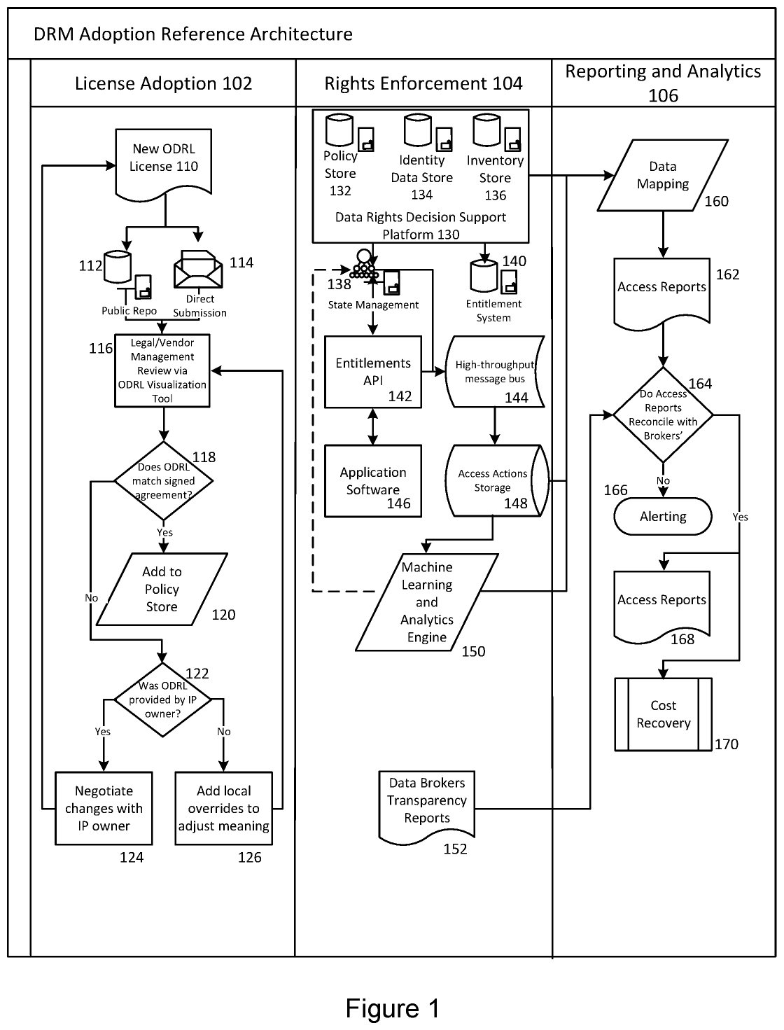

FIG. 1 is an exemplary process flow, according to an embodiment of the present invention. FIG. 1 illustrates innovative processes and corresponding systems relating to License Adoption 102, Rights Enforcement 104 and Reporting and Analytics 106.

An embodiment of the present invention recognizes that in order to obtain benefits from digital contracts, a particular process is needed to streamline the analysis and adoption. For example, NYSE can generate licenses with a standard set of terms and conditions to an entity, such as a financial institution. The financial entity may then convert the standard set of terms and conditions to ODRL and then share the information to various users to ensure compliance and common understanding of usage, rights and obligations.

An embodiment of the present invention is directed to validating the digital contract and confirm that it matches the source document (which may be the paper contract or other format). An embodiment of the present invention may determine whether an entity agrees to the agreement (e.g., digital contract) or not. If agreement is reached, the contract may be stored in a file system. If an agreement is not reached, further decisioning may be required to resolve the issues. If the contract was received from the owner (in this example, NYSE), an embodiment of the present invention may then facilitate negotiations or other communication with the owner to resolve any issues. If the contract was received from an entity that did not originate the contract, the entity may instead perform an override and resolve any inconsistencies. This may involve performing a corrective action and informing the vendor or other party. For example, an entity may override a definition. In another example, the vendor may provide a new or updated version that may then require legal approval and acceptance. Due to the ambiguity of terms and inconsistent usage and changing context, an embodiment of the present invention streamlines the process and facilitates the negotiation and correction steps. In addition, an embodiment of the present invention provides support or proof that enables an entity to confidently consume information in a manner that is consistent with rights and obligations as understood by the entity.

Under License Adoption 102, a new ODRL license may be received at 110. ODRL may represent a policy or rights expression language that provides a flexible and interoperable information model, vocabulary, and encoding mechanisms for representing statements about the usage of content and services. ODRL represents one illustrative example of rights expression language. The various embodiments of the present invention may be applied to other rights expression language license agreements. The ODRL license may cover financial services related terms and conditions. The ODRL license may be provided from various data sources, including exchanges, external contributors, data brokers, etc. The ODRL license may also be generated by third parties that do not own the underlying intellectual property or by an entity implementing the architecture describe herein. Intellectual property may refer to market data, enriched market data and/or other proprietary information, knowledge and/or know-how. The ODRL license (or components of the license) may be stored in a repository shared by multiple entities (e.g., GitHub, etc.) represented by 112. According to another example, the ODRL license may be directly submitted into this process, as represented by 114.

An embodiment of the present invention may then validate the received agreement. A review of the ODRL license may be performed by a legal or vendor management representative. An embodiment of the present invention may be integrated with a visualizer tool, such as an ODRL Visualizer that visualizes and converts complex machine readable language into understandable language for non-technical and other users. The review may be performed via ODRL Visualization Tool, the details of which are provided in co-pending and commonly owned U.S. Patent Application, Ser. No. __/______, entitled “System and Method for Implementing an Open Digital Rights Language (ODRL) Visualizer,” (Attorney Docket No. 72167.001920), which claims priority to U.S. Provisional Application Ser. No. 62/957,443, entitled “System and Method for Implementing an Open Digital Rights Language (ODRL) Visualizer,” (Attorney Docket No. 72167.001810), the contents of which are incorporated by reference herein in their entirety.

An embodiment of the present invention may determine whether the ODRL matches a corresponding signed agreement that carries the force of law at step 118. If yes, the ODRL may be added to Policy Store at 120. If not, an embodiment of the present invention may determine whether the ODRL was provided by an intellectual property owner at step 122. If yes, changes may be negotiated at step 124 and then result in a new (or updated) ODRL agreement that would restart the process at 110. If not, local overrides may be added to adjust and/or modify the meaning of certain terms at step 126. If overrides are added, the newly modified agreement may re-enter the process at step 116. Steps 116 through 126 may iterate until step 120 is reached.

Under Rights Enforcement 104, Data Rights Decision Support Platform 130 may include multiple data stores, such as Policy Store 132, Identity Data Store 134 and Inventory Store 136.

Policy Store 132 may store the latest ODRL documents as well as other related data and further manage metadata. For example, Policy Store 132 may store and manage ODRL documents, including various versions, applications, description of rights and applications, identification of parties and/or other information.

Identity Data Store 134 may represent user identification data, such as user identifier, name, location, group association, organizational data/codes, rights/entitlements, etc. Identification data may include user roles, groups of users, access, permissions, and other attributes that may be specific to an entity, e.g., company, etc. Identity Data Store 134 may store and manage user identities or identifiers across various sources and systems, applications, etc. Identity Data Store 134 may be specific for an organization and therefore may be different from entity to entity. For each user, Identity Data Store 134 may store and manage corresponding information concerning how the user fits in the organization, e.g., user123 is part of the index business. This information may be useful in determining whether a user can use certain data in a particular way. An embodiment of the present invention may recognize each user and a corresponding association. This may include organizational codes, group association, backgrounds, line of business, business location (e.g., building, floor, etc.), manager, managing officer, permissions, access level, security, etc.

Inventory Store 136 may store and manage inventory data. For example, Inventory Store 136 may manage data relating to securities, tickers and reference data which may be mapped to information stored in Policy Store 132. An embodiment of the present invention recognizes that various exchanges, distribution vendors and other entities may refer to the same asset using different terms and/or identifiers. An embodiment of the present invention may utilize an Inventory Store 136 to manage and track the various different identifiers used for the same asset, for example. This is particularly useful when a client submits a query relating to whether a certain action can be taken with respect to a specific asset. An embodiment of the present invention recognizes that it is critical to know that the specific asset is properly identified through various sources. For example, an entity would need to know which policy to apply to the properly identified asset. Accordingly, an embodiment of the present invention may manage and properly map reference data.

Data Rights Decision Support Platform 130 may support various different databases and data sources as well as different data models in various stores with different database technologies. For example, inventory data may map into a relational model whereas policy data may be managed in a graph database. Other variations may be supported.

Entitlement System 140 may be accessed to retrieve entitlement data. This may be useful to communicate with legacy entitlement systems and new systems running in parallel. An exemplary entitlement system may include Refinitiv's Data Access Control System (DACS). Other entitlement systems may be implemented. State Management 138 may be responsible for maintaining the current state of data entitlements, and may include a system for managing entitlements, the details of which are provided in co-pending and commonly owned U.S. patent application, Ser. No. 16/563,106, entitled “System and Method for Implementing Market Data Rights Enforcement” (Attorney Docket No. 72167.001770).

State Management 138 may communicate with Entitlements API 142 and High-throughput message bus 144. Entitlements API 142 may communicate with Application Software 146 as well as High-throughput message bus 144. Entitlements information may include specifics concerning the data, including who asked for what data, how the data will be used, when the data was requested, why access was denied/granted, etc. High-throughput message bus 144 may store data in Access Actions Storage 148. Data may be fed into Machine Learning and Analytics Engine 150. Data may be fed back into State Management 138 in order to make adjustments to entitlements and/or other data. This information may be managed in real-time or near real-time so that adjustments may be made based on certain patterns that are being detected. For example, this information may be used to make predictions, identify trends, potential abuse of entitlement information, etc. For example, an embodiment of the present invention may detect that a particular user has accessed information that is normally not accessed and then track the user's usage using the entitlement system to confirm compliance.

Under Reporting and Analytics 106, Data Mapping 160 may receive data from Data Rights Decision Support Platform 140, Access Actions Storage 148, and/or Machine Learning and Analytics Engine 150. Data Mapping 160 may generate Access Reports 162. An embodiment of the present invention may determine whether access reports reconcile with corresponding reports generated by data brokers at step 164. If yes, Access Reports 168 may be generated or communicated and Cost Recovery may be determined at step 170. Cost Recovery may also involve identifying who used what data, how data was used, rules regarding allocation, rules about consumption, etc. If not, alerting may be performed at 166. Alerting may be performed via various modes of communication. The determination of step 164 may also receive input from Data Broker's transparency reports represented by 152. Transparency reports may identify users who are asking for certain information at time periods and/or intervals. An embodiment of the present invention is directed to providing insights and patterns through various reports.

While the process of FIG. 1 illustrates certain steps performed in a particular order, it should be understood that the embodiments of the present invention may be practiced by adding one or more steps to the processes, omitting steps within the processes and/or altering the order in which one or more steps are performed.

The various embodiments of the present invention may be applied to uses cases and applications beyond market data with licensed information. For example, scientific literature may be licensed to libraries under restrictive terms in a similar manner as Market Data. In addition, the license adoption described herein may be applied to general supply chain management, which also deals with complex agreements on wide array of assets. Other applications and scenarios may be supported.

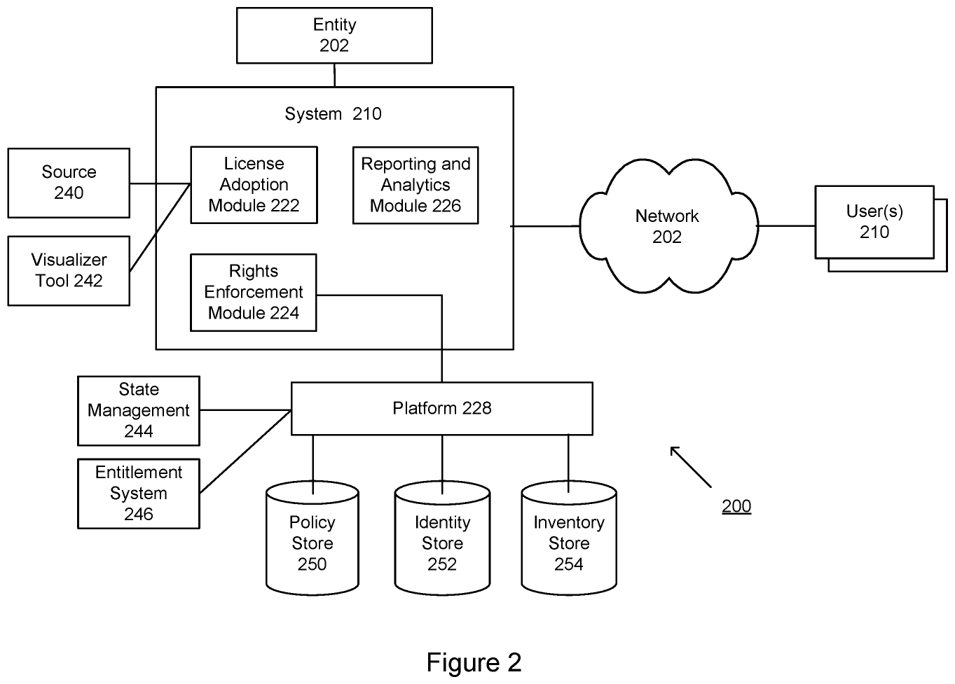

FIG. 2 is an exemplary system diagram, according to an embodiment of the present invention. FIG. 2 may include System 210 with various modules and functions that support data rights management. System 210 may include License Adoption Module 222, Rights Enforcement Module 224 and Reporting and Analytics Module 226. License Adoption Module 222 may receive data from various sources, represented by Source 240. For example, a license agreement may be received from a repository or via a direct submission. License Adoption Module 222 may interact with a Visualizer Tool 242 to view and access details concerning terms, rights and obligations associated with digital contracts and other agreements. For example, an embodiment of the present invention may be integrated with a Visualizer Tool 242, such as an ORDL visualizer that automatically translates digital agreements from machine readable language into human readable language. Rights Enforcement Module 224 may interact with Platform 228. Platform 228 may communicate with State Management 244 and Entitlement System 246. Platform 228 may access data managed by Policy Store 250, Identity Store 252 and Inventory Store 254. Reporting and Analytics Module 226 may support various functionality including data mapping, reporting and alerts. System 210 may further store data relating to agreements, contracts, terms, analytics, visualizations, digital and other rights, etc. Data Stores may represent a graph database and/or other analytics system.

Entity 202, such as a financial institution, may host System 210. Users 210 may interact with System 210 via Network 202. While FIG. 2 illustrates individual devices or components, it should be appreciated that there may be several of such devices to carry out the various exemplary embodiments. Users may communicate with various entities using any mobile or computing device, such as a laptop computer, a personal digital assistant, a smartphone, a smartwatch, smart glasses, other wearables or other computing devices capable of sending or receiving network signals.

The system 200 of FIG. 2 may be implemented in a variety of ways. Architecture within system 200 may be implemented as hardware components (e.g., module) within one or more network elements. It should also be appreciated that architecture within system 200 may be implemented in computer executable software (e.g., on a tangible, non-transitory computer-readable medium) located within one or more network elements. Module functionality of architecture within system 200 may be located on a single device or distributed across a plurality of devices including one or more centralized servers and one or more mobile units or end user devices. The architecture depicted in system 200 is meant to be exemplary and non-limiting. For example, while connections and relationships between the elements of system 200 are depicted, it should be appreciated that other connections and relationships are possible. The system 200 described below may be used to implement the various methods herein, by way of example. Various elements of the system 200 may be referenced in explaining the exemplary methods described herein.

Network 202 may be a wireless network, a wired network or any combination of wireless network and wired network. For example, Network 202 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, Network 202 may support an Internet network, a wireless communication network, a cellular network, Bluetooth, or the like, or any combination thereof. Network 202 may further include one, or any number of the exemplary types of networks mentioned above operating as a stand-alone network or in cooperation with each other. Network 202 may utilize one or more protocols of one or more network elements to which it is communicatively coupled. Network 202 may translate to or from other protocols to one or more protocols of network devices. Although Network 202 is depicted as one network for simplicity, it should be appreciated that according to one or more embodiments, Network 202 may comprise a plurality of interconnected networks, such as, for example, a service provider network, the Internet, a cellular network, corporate networks, or even home networks, or any of the types of networks mentioned above.

Data may be transmitted and received via Network 202 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

System 210 may be communicatively coupled to data stores. Data stores may include any suitable data structure to maintain the information and allow access and retrieval of the information. For example, data stores may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

The storage may be local, remote, or a combination thereof with respect to the data stores of FIG. 2. Data stores may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Data stores may have back-up capability built-in. Communications with data stores may be over a network, or communications may involve a direct connection between data stores and Entity 202, as depicted in FIG. 2. Data stores may also represent cloud or other network based storage.

Other embodiments, uses, and advantages of the invention will be apparent to those skilled in the art from consideration of the specification and practice of the invention disclosed herein. The specification and examples should be considered exemplary only, and the scope of the invention is accordingly not intended to be limited thereby.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements a reference architecture for adopting digital rights management, the system comprising:
an electronic input configured to receive license data from one or more sources; and
a computer processor coupled to the electronic input and further programmed to perform the steps of:
receiving, via the electronic input, a license agreement in rights expression language;
performing, via a visualization tool, a validation of the license agreement;
identifying a source of the license agreement;
based on the identified source, initiating an override or a negotiation of one or more terms of the license agreement; and
upon validation of the license agreement, storing, via a policy store, one or more terms of the license agreement;
wherein the risk of accepting terms that are different from a negotiated paper agreement are substantially minimized.

2. The system of claim 1, wherein the source of the license agreement is an owner of the license agreement.

3. The system of claim 1, wherein the source of the license agreement is a third party.

4. The system of claim 1, wherein the license agreement comprises an Open Digital Rights Language (ODRL) license agreement.

5. The system of claim 1, wherein the license agreement is directly submitted.

6. The system of claim 1, wherein the license agreement is retrieved from a repository.

7. The system of claim 1, wherein responsive to the override or the negotiation of one or more terms of the license agreement, updating the license agreement.

8. A system that implements a reference architecture for adopting digital rights management, comprising:
a platform that manages multiple data stores comprising a policy store, identity data store and inventory store; and
a computer processor coupled to the platform and further programmed to perform the steps of:
accumulating a plurality of digital license agreements in rights expression language;
identifying one or more entitlements associated with the license agreement in rights expression language, wherein the one or more entitlements comprise multiple parameters comprising: identity of an intended user, content associated with the license agreement and how the content is to be used; and
applying, in real-time, analytics to the one or more entitlements to identify one or more of: predictions, trends, one or more errors and potential abuse of entitlement information;
wherein rights enforcement is expanded to a multi-dimensional view that considers the multiple parameters to enable decision making in real-time.

9. The system of claim 8, wherein the license agreement comprises an Open Digital Rights Language (ODRL) license agreement.

10. The system of claim 8, wherein one or more adjustments are made to the one or more entitlements based a machine learning analysis.

11. The system of claim 8, wherein the policy store stores and manages the license agreement including one or more previous versions, one or more related applications and a description of rights and obligations.

12. The system of claim 8, wherein the identity data store comprises user identification data and corresponding organization data.

13. The system of claim 8, wherein the inventory data store stores and manages mapped data relating to securities, tickers and reference data to accurately identify one or more assets defined by one or more digital license agreements.

14. The system of claim 8, wherein the computer processor is further programmed to perform the step of:
generating one or more data broker transparency reports relating to data requests.

15. A system that implements a reference architecture for adopting digital rights management, comprising:
an electronic input in communication with a real-time analytics and machine learning system; and
a computer processor coupled to the electronic input and further programmed to perform the steps of:
performing data mapping based on machine learning data from the electronic input and one or more decisions made by at least one entitlement system;
applying analytics, based on the data mapping, that capture a plurality of metrics comprising: whether information was accessed, how the accessed information was used, whether the access was compliant with one or more policies;
responsive to a user request, automatically generating one or more access reports comprising the plurality of metrics associated with the license agreement; and
displaying, via an interactive user interface, the one or more access reports;
wherein multiple data dimensions are introduced into the data mapping process and automated generation of reports.

16. The system of claim 15, wherein the license agreement comprises an Open Digital Rights Language (ODRL) license agreement.

17. The system of claim 15, wherein the one or more access reports comprise a cost recovery analysis that identifies one or more of: who used what data, how data was used, one or more rules regarding allocation and one or more rules about consumption.

18. The system of claim 15, wherein one or more alerts are generated and transmitted.

19. The system of claim 15, wherein the data mapping is further based on data from a data rights decision support system.

20. The system of claim 19, wherein the data rights decision support system comprises a policy store, an identity data store and an inventory store.
